(19) United States
(12) Patent Application Publication
(10) Pub. No.: US 2017/0132396 A1
(43) Pub. Date: May 11, 2017

(54) System and Method for Recurring Measurement and Actionable Outcomes to Meet Clinical Timespans

(71) Applicant: Wellbridge Health, Inc., Pittsburgh, PA (US)

(72) Inventors: Jody Bechtold, Pittsburgh, PA (US); David Watson, Pittsburgh, PA (US); Robert Dickenson, Jersey City, NJ (US)

(21) Appl. No.: 15/347,511

(22) Filed: Nov. 9, 2016

Related U.S. Application Data
(60) Provisional application No. 62/252,959, filed on Nov. 9, 2015.

(51) Int. Cl. G06F 19/00

(52) U.S. Cl. CPC G06F 19/363; G06F 19/345; G06F 19/328

(57) ABSTRACT

An MCM system is provided for multiple audiences or programs for a system and method of handling participants. The MCM eliminates unnecessary human decision making by using measurements of key data to algorithmically determine future actions. The individual systems are programmed to handle recommendations of content (content management) and to produce workflow, reports, and analytics based on the core content of a program. The MCM system is used to manage participant behaviors, for example, those involved in Population Health Management, Care Management, Managed Care, treatment/care/behavior planning, and workforce development. The MCM provides recommendations and predictions about patients from a specific healthcare plan or patients sharing similar conditions. This system has recurring measurements and actionable outcomes that allow participants to meet their goals incrementally over established clinical timespans.

### CROSS REFERENCE TO RELATED APPLICATION

This application claims the benefit of U.S. Provisional Application No. 62/267,472, filed Dec. 15, 2015, the entire disclosure of which is hereby incorporated by reference in its entirety.

### BACKGROUND OF THE INVENTION

### Field of the Invention

The potentially high costs of health care are associated with almost all disease and ailments today. A knowledge-based self-management approach seems to reduce health care costs, improve disease control, and reduce indirect costs. A significant association between patient knowledge and health care costs exists.

Higher levels of knowledge were shown to be associated with significantly lower health care costs. Better information can lead to better choices and improved outcomes. Increased patient information and education has become more important, and a priority for managing patients with a number of serious diseases.

Medicare alone currently spends more than $25 billion a year on rehospitalizations, and in 2014 estimated the total cost to be more than $40 billion. In addition, readmission programs put strain on hospitals and cause distress and dissatisfaction to patients who repeatedly find themselves back in the hospital.

A whopping three-quarters of readmissions could likely be avoided with better care, reported a 2007 congressional report by the Medicare Payment Advisory Commission, and hospitals, insurance companies, and the US Congress have taken notice. Specifically, under the new federal healthcare law, the Centers for Medicare & Medicaid (CMS) services will use a 30-day cutoff to start penalizing hospitals with higher than expected rates of readmissions, starting in 2012, and may ultimately refuse payment for selected diagnoses that occur within this timeframe. Health reform legislation also initiates a closer look at global payment systems, with a number of pilot projects planned that would include reimbursement per diagnosis as opposed to each service, including readmissions, related to a diagnosis.

The causes of readmissions vary widely. While in some cases, patients' conditions may unavoidably get worse, many patients return to the hospital quickly because of an error that occurred during their first visit. Estimates exist that one in five patients has a complication or an adverse event, such as a drug interaction, after being discharged from the hospital, drastically increasing their odds of a costly emergency room visit or readmission.

These patients want and need to avoid hospitalization just as much as their doctors and other care providers want to keep them out of the inpatient setting. Heart failure has been one of the least well-managed conditions. Part of the challenge in managing heart failure is predicting when patients will end up back in the hospital. In the past, there has been no good way to anticipate changes in patient status before heart failure symptoms emerge, and once a patient shows up at the emergency room with fluid in the lungs, it is too late.

### SUMMARY OF THE INVENTION

To help change or stop rehospitalization, a system and method are used to increase knowledge of patients about their disease and management of the disease in a post-hospital care plan. The system uses specially programmed systems to help participants arrange follow-up appointments, confirm medication routines, and understand their diagnoses using several different processes, both tactically and strategically.

The MCM (member confidence measure) system provides multiple audiences or programs a system and method for handling participants to eliminate unnecessary human decision making by using measurements of key data to algorithmically determine future actions. The individual systems are programmed to handle content (content management) and produce workflow, reports, and analytics based on the core content of a program. The MCM system is used to manage participant behaviors, for example, those involved in Population Health Management, Care Management, Managed Care, treatment/care/behavior planning, and workforce development. A program can involve patients from a specific healthcare plan or patients sharing similar conditions. This system has recurring measurements and actionable outcomes which allow participants to meet their goals incrementally over established clinical timespans.

The MCM system operates to provide treatment, care, and behavior plans in an individualized manner. The MCM system can be operationalized for an entire population while producing measurable outcomes for individuals. The MCM system guides focus on and individually quantifies treatment using topical disease education for participants. The system improves clinical judgment using a combination of structured and unstructured data, which are indicia used to create actionable outcomes for the coach, the team, and the client, and clinical business projections.

### BRIEF DESCRIPTION OF THE DRAWINGS

FIG. 1 is a diagram illustrating the union of participant, worker, and member confidence measures to identify knowledge and understanding of a participant;

FIG. 2A illustrates a dashboard depicting knowledge factors of one embodiment of the invention for a participant;

FIG. 2B illustrates a visual diagram showing the flow of MCM results through a dashboard to a social worker team;

FIG. 3 illustrates the steps of a method of participant validation and associated computation of a coach's score;

FIG. 4 is a diagram of data flow in a member confidence measure system of the present invention;

FIG. 4 shows an embodiment of data relating to the participants;

FIG. 5A illustrates a representative set of questions for use in checking a patient's mood;

FIG. 5B illustrates a representative dashboard for confirming a patient's knowledge in a post hospitalization program;

FIG. 6 is a use-case diagram describing an exemplary weighting for topics of education;

FIG. 7 illustrates a relational schema 700 describing the logical definition of tables of the present invention;

FIG. 8 illustrates a representative set of icons for use in self-checking a patient's mood; and

FIG. 9 shows an exemplary computer environment.

### DESCRIPTION OF THE INVENTION

For purposes of the description hereinafter, the terms and derivatives used to describe the figures shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt, transmission, or transfer of one or more signals, messages, commands, or other type of data. The terms “member”, “patient”, and “participant” refer to the subject of the MCM, a participant that has an ailment, disease, problem, or issue for which the MCM is used to educate, track, monitor or aggregate, and recommend content. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc. between the first and second unit or device. It will be appreciated that numerous other arrangements are possible.

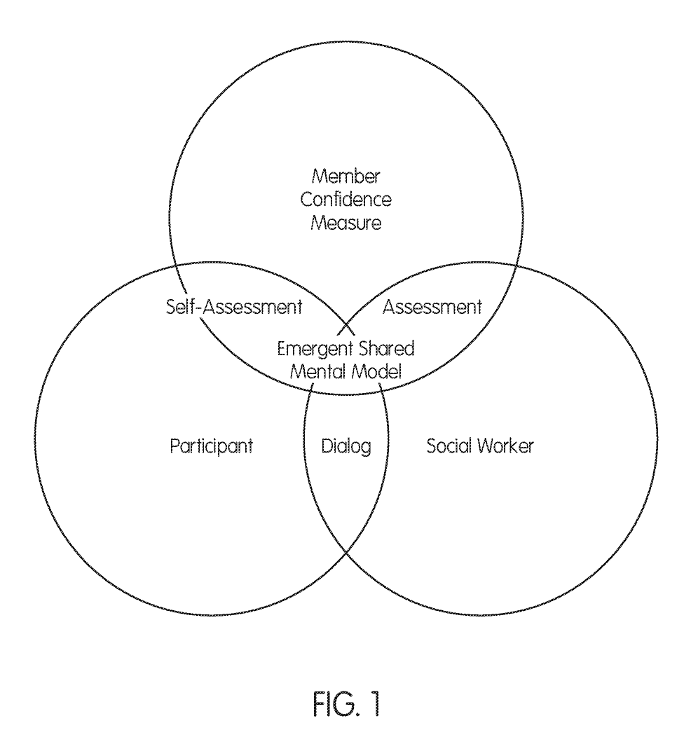

With reference to FIG. 1, a diagram is shown of a picture representing the union of the understanding of principles by the sets of participants, social workers, and member confidence measure. In FIG. 1, understanding is associated with knowledge about a set specific ailment, outcome, or symptom of an ailment. Mathematical or logical sets representing the participants and social worker pictorially as circles within an enclosing rectangle (the universal set), common elements of the sets being represented by the areas of overlap among the circles. In the diagram, propositions are modeled as concrete relation bonds between the entities. In FIG. 1, the shared understanding is represented as the totality of such relations that apply to the members. The visualization here represents the narrow shared knowledge about a patient or participant's understanding of the particular ailment or disease and the symptoms related. The participant and social worker participate in dialog to narrow and synchronize their knowledge. In addition, the participant patient engages in the MCM self-assessment and the social worker engages in assessment to further narrow an understanding or awareness of the patient's understanding of their situation.

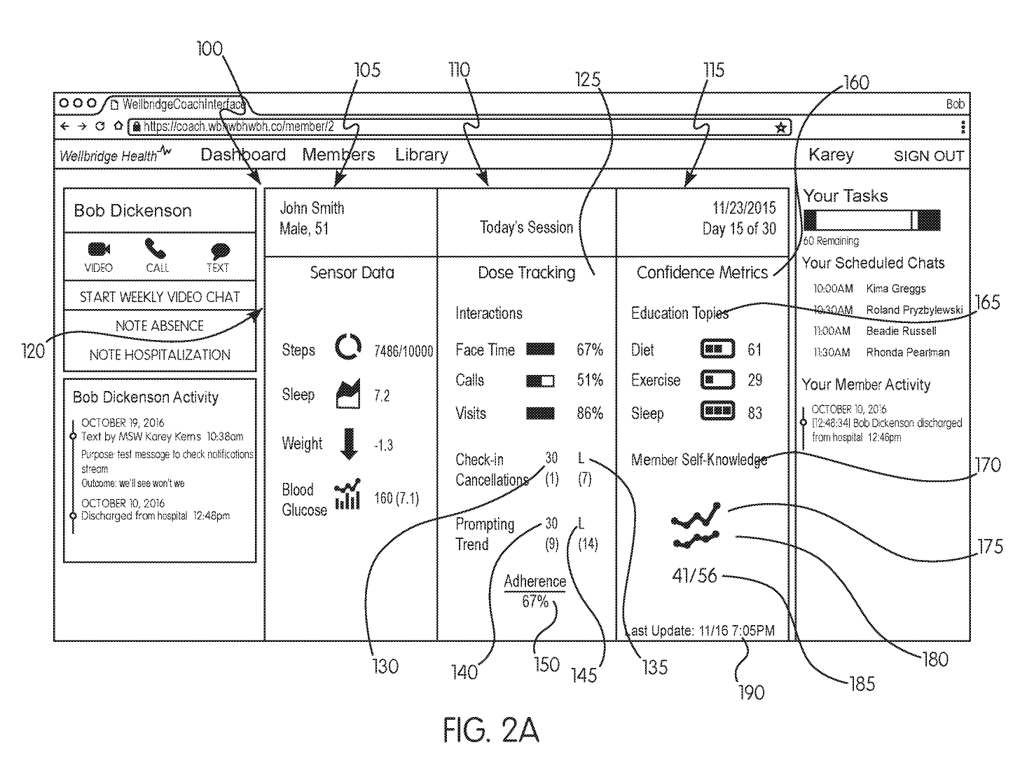

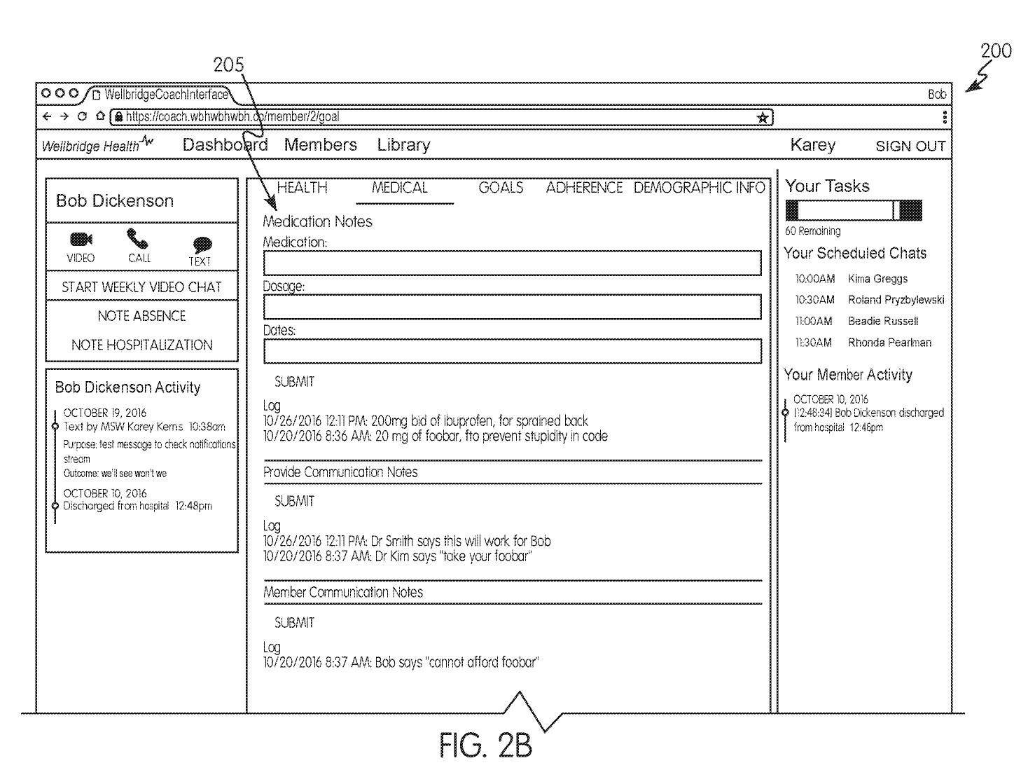

With reference to FIG. 2A, a dashboard 100 of the MCM application displays participant information for providing health and medical workers quick and logical access into the system defined parameters and data views, providing a quick look at participant information. The dashboard includes frames for sensor data 105, dose tracking 110, and general confidence metrics information 115. The dashboard is used for representing data relating to participants using predictive modeling of statements that are stored in the database systems. The predictive model is used to prepare workflows, recommend data or content, apply programs, and eliminate or decrease hospitalization, among others. In an embodiment, in at least one embodiment, the MCM, acting as a recommendation or search engine, recommendations are generated by the model and displayed for a participant, social worker, coach, team, or other user relating to the treatment plan of a participant. Statement data is determined from information stored in a database and used in predictive modeling algorithms to predict and control behavior change. Predictive models use disparate information, in some cases across time, from a first period to make determinations or guesses about behaviors, such as that of a patient having a particular disease for managing the disease in a subsequent time period. The predictions aid the increase of knowledge for the participant about their disease and for the worker, in understanding more about the participant's knowledge of the disease and understanding treatment.

With reference to FIG. 2B, the data structures are displayed on a member organizer application 200 that serves to organize a member, i.e. worker, and the participants they are assigned to. At least one goal of the MCM is positive behavior change for participants or groups of participants sharing similar traits. One example of positive behavior change is increasing understanding about a disease to a point where hospitalization or emergency room visits are decreased. In one embodiment, the social worker is given a focused set of educational topics which they can use to address and promote change with a participant during the subsequent time period. Similar to the dashboard of FIG. 2a, the member organizer 200 includes various fields from the MCM. For example, medication notes 205 and goals 210 respectively, are set, updated and changed, dated and changed from inside organizer application 200.

Sensor data 105 includes fields 120 for displaying information received from sensor devices communicating with the system and associated with the participant, such as steps, sleep, weight, and blood glucose. For example, participants couple their scale for weighing to the system from a remote location by attaching the scale to the application. For example, the sensor (a scale) can be attached to the participant's remote computer. The remote computer can communicate by sending messages to the MCM through a network, such as the internet, an intranet, mobile network, SMS, or any other network protocol. Other devices, such as blood glucose level sensor, sleep monitor device, coagulation sensor, or other medical and physical sensors, may be coupled to the application. In addition, calculated fields based on the information gathered from these different sources can be displayed in combinations or as the basis for other statistically significant calculated fields. For example, based on weight, visual representations can be displayed showing daily trends, i.e., up or down, 5-day change, weekly, 30-day, monthly, or some other aggregation. Sleep tracking is similarly tracked and displayed, with metrics. Sensor data displays information that is stored in the database associated with the particular sensor for the relevant period. In an embodiment of the invention, when sensor information is outside of the norm, for example, weight loss is more than a value, such as a predefined value, then a warning is sent to a medical or health care worker.

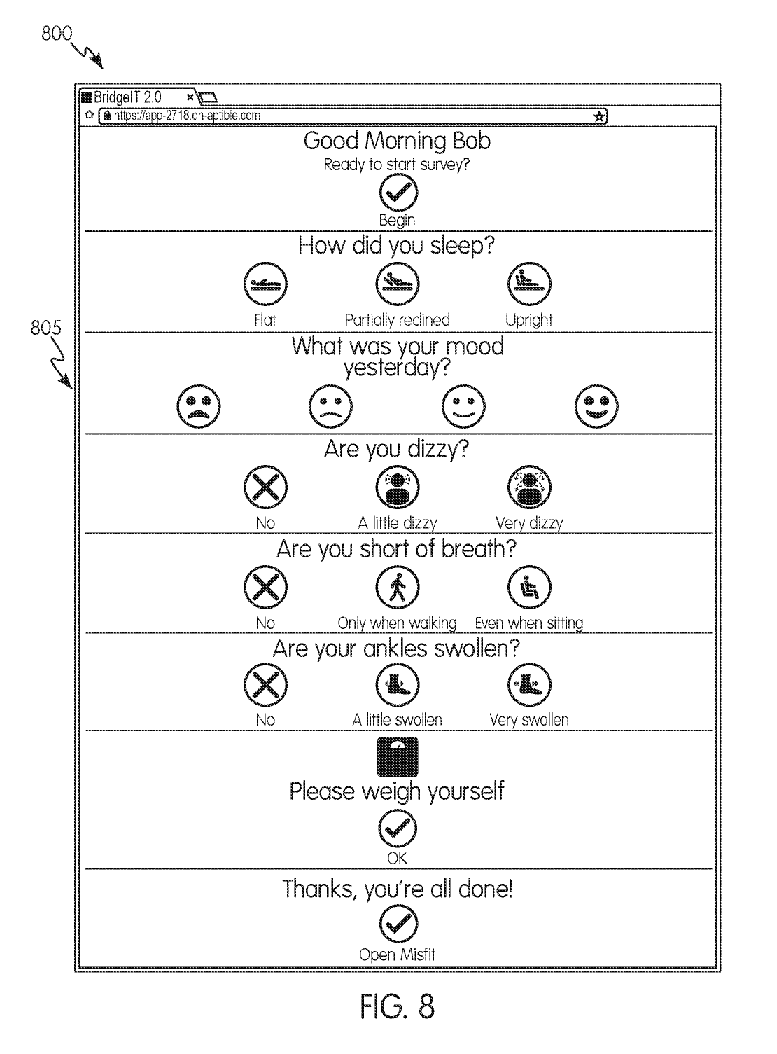

With further reference to FIG. 2A, dose tracking 110 includes information about interactions 125 a worker has conducted with the patient, such as facetime, calls, or in-person visits. Check-in and cancellations are also tracked, in addition to conditions of the participant at the time of check-in, such as ankle swelling, shortness of breath, sleep position, dizziness, and mood. In addition, other questions are used that measure coherency in the system, and that information is used for display (see FIG. 8). Dose tracking 110 is also used to show measured total number of check-ins 130, average check-in 135, and number of cancellations. Prompting and trends are displayed to visually represent the results of the prompting exercise, also measured and tracked, with viewable statistics shown in the tracking section 125 of the dashboard, including the number of promptings completed 140, average 145, trend of the prompting. Participant adherence 150 measures and displays numeric value associated with a participant's devotion to the rules associated with a health plan enacted in coordination with the social worker and MCM system. Other forms such as graphical representations can supplement and/or replace the numeric representation.

Confidence metrics 160 include indicators of MCM recommendations for improving a participant's outlook. The MCM can be used a recommendation engine, where education topics 165, that are recommended to the participant based on a specific condition are transmitted, displayed, and/or made available to the participants. For example, diet information is recommended to a patient suffering from Chronic Heart Failure (CHF), and is displayed with a graphical bar, showing progress and number indicating completion of the recommended information about that topic. The recommendation engine is different from conventional structures because it uses actual status information from a participant, and builds a score of that status based on statements that a participant answers to provide the MCM understanding of a participants awareness of their condition. Likewise, education and sleep are indicated with graphic bars and numbers, respectively. The member self-knowledge section 170 provides representations of progress for the participant while using the system. Self-knowledge also shows visual representations of trends for check-in 175, prompting 180, and confidence scores 185. Last update 190 indicates the date and time when an update last occurred.

As new data is collected, the cycle is repeated and with each iteration, the system refines predictions. When convergence regarding a particular knowledge or behavior is established, adaptions of important lifestyle, medical, and health goals are made in the system.

With continuing reference to FIG. 2A, a dashboard can include indicators for symptoms, exercise, and medication. The indicators represent, in one embodiment, the quantity of time a participant requires for focus on a certain topic. For example, the number of hours or a percentage of time can be dedicated for a user for certain important topics. A topic is identified as important during the process by the predictive models. When selecting an indicator, such as medication, specific items (not shown) are given, which a social worker can communicate to a patient. For example, when exercise is selected, a list of links to specific content is shown. Such education is controlled for a patient and across patients.

The invention can be used to predict the efficacy of specific content to be used, questionnaires, and participant/social worker interactivity. By allowing content to be chosen and measured using MCM information across participants over time, the system can also isolate and measure organizational success. In one embodiment, a coach moves through the selections provided by the system to inform a participant. The system provides input options for recording the date and duration of discussions for each content item. A non-limiting example of such informing content would be a Wiki page, manual, video, magazine, or technical document.

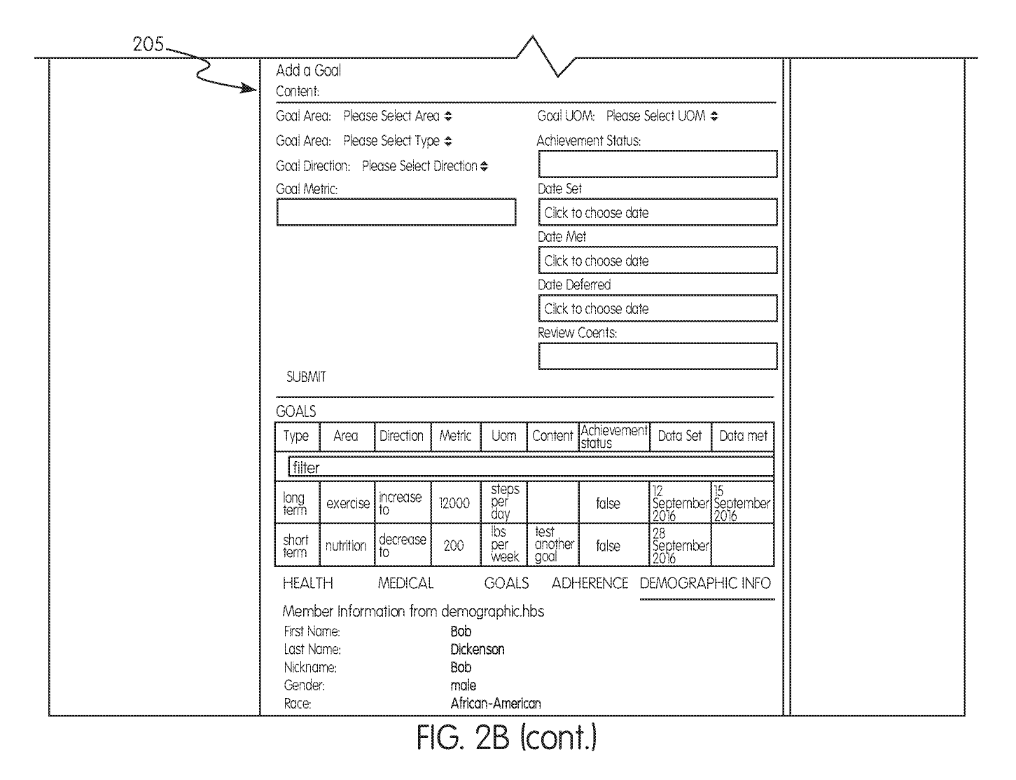

With reference to FIG. 3, a diagram is provided showing MCM 300 generally, and highlighting the interactions of the MCM team and MCM system, in order to direct a recommendation and assessment for a participant. The MCM is used to ensure that participants are completing their tasks, maintaining their health, and increasing their knowledge of the disease. A participant 305, a worker 310, a researcher 315, and a team 320 all coordinate through the MCM 300.

In the MCM, the systems send and receive questions 325 in addition to prompting follow-up questions 330 which the worker asks the participant. In one embodiment, the subject matter is disease specific. In another embodiment, the questions can be targeted to other subject matter and associated with content to help the participant. In addition, the worker 310, can be substituted for a microprocessor programmed to retrieve questions. The MCM creates efficiencies in providing recommended content, by prompting participants to ensure the proper understanding is reached about content that is desired. Questions are stored in a unique database structure or alternatively generated from information in a database and retrievable by a processor. The processor can use the participant's answered questions 325, in addition to stored information from the participant, such as sensor information, demographic information, or previously answered questions. Scoring can be used to automatically find the best questions to ask. The combination of the answered questions is used to validate the participant's knowledge at 335. Validation is provided through the use of questions about the answers or requests of a participant. If a participant answers that they are confident that they can help reduce their symptoms associated with heart failure condition, in one example, the coach, worker, doctor, or application would query the participant about issues or other factors that could impact the condition. For example, a worker may ask the participant to list as many factors as they can impacting the condition. In this example, the worker is looking for the top answers that effect CHF. The worker would be looking at answers like sodium, exercise, medication, sleep, fluid, or medical appointments. Then, based on the answers, a confidence score is given. For example, if the participant cannot describe any factors, the worker would give a low confidence score for that item. If the participant can describe one, then the score increases. The information is then passed to the database and provided in the dashboard.

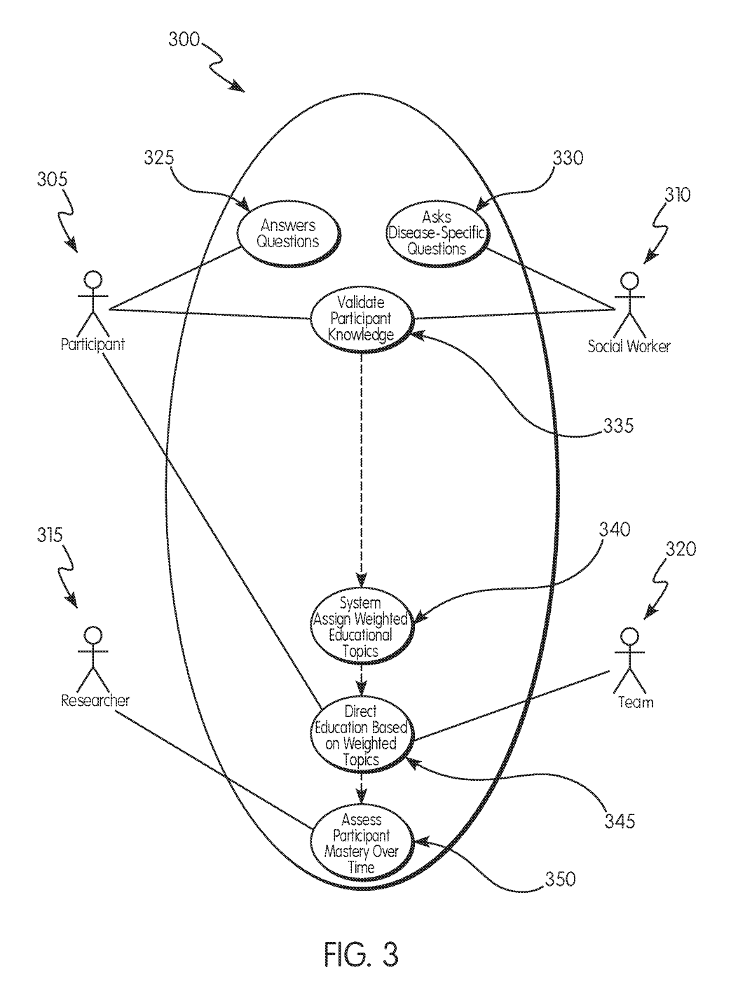

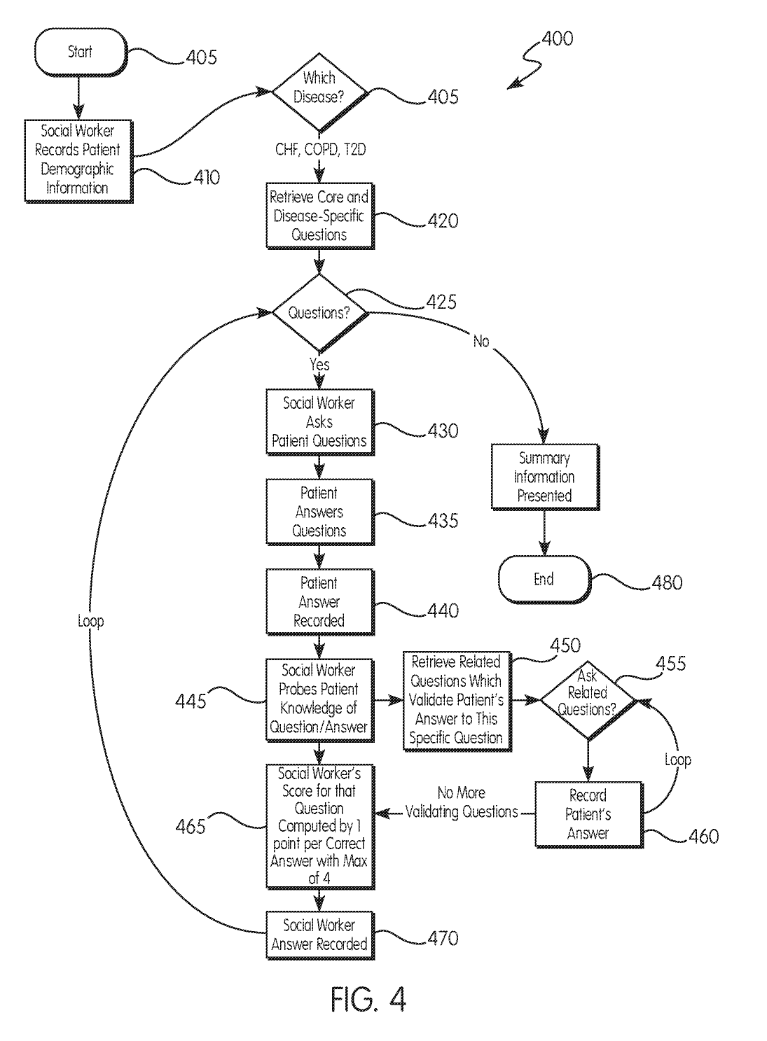

The dashboard is designed to communicate the information captured by the MCM system across multiple spaces, i.e., user space, multiple users, content, or healthcare system. With reference to FIG. 4, the steps for MCM calculation starts at 405. The patient demographic information is determined and recorded at step 410 for setting up the system. For example, the information can be retrieved through interfaces, such as additional data sources, and input. A worker can input the information, or the MCM can be programmed to check databases and search based on known information to retrieve additional information. In addition, the participant's disease is determined by the system and stored at step 415, for example CHF, Chronic Obstructive Pulmonary Disease (COPD), or Type 2 Diabetes (T2D). Other intake steps include prompting a participant for all of the member confidence survey questions by retrieving the core and disease-specific questions 420 from a database and sending application programs operative to query the participant. These questions are accessed from a question database. Examples of the questions are listed below in table 1, where a spreadsheet with a representative set of questions are given. Each question is associated with a number of prompts.

TABLE 1

| Educational Topic | Question | Statements |
|---|---|---|
| Managing Heart Failure CHF | I am confident that I will know | Weight Increase; Swollen |
| Symptoms | when my Heart Failure (HF) | Ankles; Shortness of Breath; |
| BridgIT Symptoms | symptoms are getting worse. | Sleeping Upright; Dizziness |
| Medication Safety | I can identify what each of my | Cannot Describe Less Than 50% |
| Medical Appointments | medications does. | of Cc; More than 50% of Cc; |
| | | Includes Other Medical/Mental; |
| | | Otc |
| Healthy Eating | I am confident I can help | Sodium; Fluid; Exercise; |
| Physical Exercise | reduce symptoms associated | Medication; Sleep; Medical |
| Quality of Sleep | with my heart failure condition. | Appointment |
| Medication Safety | | |
| Medical Appointments | I know the importance of my | Does Not Understand Pcp; Does |
| | medical appointments. | Not Understand Specialist; |
| | | Does Not Understand Vision; |
| | | Does Not Understand Dental |
| Risk for Falls | I know how to prevent being at- | Cannot Describe Medications; |
| Home Safety | risk for falls in my home. | Loose Carpets; Stairs; |
| Physical Exercise | | Shower/Bath; Lack of Exercise; |
| | | Need for Rollator/Walker |
| Healthy Eating | I am confident that I can follow | Read Labels; Salt Substitute; |
| | a low sodium diet on a regular | Healthier Food; Good Choices - |
| | basis. | at home; Good Choices - eating |
| | | out |
| Managing HF | I understand which Heart | Swelling; Breathing; Chest Pain; |
| BridgIT symptoms | Failure (HF) symptoms affect me | Other HF Symptoms |
| Medication safety | the most. | |
| Medication Safety | I know how to use a pill-box or | Does Not Have A Pill Box or |
| Medical Appointments | schedule for all my medications. | System; Has a System; Has A Pill |
| Memory Problems | | Box; Cannot Modify Doctor |
| | | Changes; Can Modify Doctor |
| | | Changes |
| Healthy Eating | I am able to keep up with | |
| Physical Exercise | necessary changes in my diet | |
| | and exercise. | |
| Medical Appointments | I am able to keep all my | Does Not Go; Does Not Have |
| Transportation Issues | doctors' appointments | Reliable Transportation; Keeps |
| | (schedule & transportation) | Most With Reminders; Keeps |
| | | Most With Transportation; |
| | | Keeps All With Transportation |
| Substance Use | I understand how drinking | Cannot Describe; Does Not |
| | alcohol affects my HF symptoms | Drink; Medication Interactions; |
| | | Constricted Blood Vessels |
| Smoking Cessation | I understand how smoking | Cannot Describe; Does Not |
| | cigarettes affects my HF | Smoke; Damage Blood Vessels; |
| | symptoms | Oxygen Levels; Heart Attack |
| | | Risk |
| Managing Type 2 Diabetes | I am confident that I will know | |
| Symptoms | when my blood sugars (T2D) are | |
| | too high. | |
| Managing Type 2 Diabetes | I am confident that I will know | |
| Symptoms | when my blood sugars are too | |
| | low. | |
| Managing Type 2 Diabetes | I am confident I can help | |
| Symptoms | reduce symptoms associated | |
| | with my Type 2 Diabetes | |
| | condition. | |
| Medical Appointments | I am confident I will know when | Cannot Give Examples; Dizzy; |
| BridgIT symptoms | I need to go to the doctor or | Shortness of Breath; Chest |
| Managing HF CHF symptoms | emergency room | Pains/Tightness; Difficulty |
| | | Breathing; Low Blood Sugar; |
| | | Fluid |
| Quality of Sleep | I am confident that I get | |
| | enough sleep/rest each night. | |
| Healthy Eating | I know the importance of | |
| Physical Exercise | physical exercise. | |
| Healthy Eating | I am confident that I can follow | |
| Physical Exercise | a low carb diet on a regular | |
| | basis. | |
| Managing Type 2 Diabetes | I understand the longer-term | |
| Symptoms | effects of unmanaged diabetes. | |
| Substance Use | I understand how drinking | |
| | alcohol affects my diabetes | |
| | (Type 2) symptoms. | |
| Smoking Cessation | I understand how smoking | |
| | cigarettes affects my diabetes | |
| | (Type 2) symptoms. | |
| Managing Asthma/COPD | I am confident that I will know | |
| Symptoms | when my Asthma/COPD | |
| | symptoms are getting worse. | |
| Managing Asthma/COPD | I am confident I can help | |
| Symptoms | reduce symptoms associated | |
| | with my asthma/COPD | |
| | condition. | |
| Managing Asthma/COPD | I understand which | |
| Symptoms | COPD/Asthma symptoms affect | |
| | me the most. | |
| Smoking Cessation | I understand how smoking | |
| | cigarettes affects my | |
| | asthma/COPD. | |

With reference to FIG. 4, a diagram shows the steps for capturing the participant specific information captured by the coach. The coach has the MCM on a mobile device such as a tablet or computer. In step 1, the coach selects the participant demographic information. If this is the first time administering the MCM, the coach may need to enter other participant demographics, including chronic conditions and other client-specific details. The total number of questions used for each MCM varies based on the number of chronic conditions being addressed for each participant. The total score will be dependent on the overall number of questions as well.

Returning to FIG. 4, in step 2, for each statement, the participant is asked to answer each question. Answers are limited, such as No, Somewhat, Mostly, or Yes, where each answer corresponds to a numeric rating of 1-4, respectively. One of ordinary skill in the art would understand that other possible scaling and controls would exist. The complexity of the answers is limited to the subject matter, for example, sending the question with embedded statements that can be conditionally tested.

Step 3 is a probe of the user. The coach prompts the participant for specific examples or actions that support their reported answer. A list of the accepted answers is displayed to the coach. If the participant gives one of those answers, the coach assigns a check in a check box to that example. As the patient exhausts the extent of their knowledge regarding a certain question, a tally is completed quantifying exactly how much a patient knows about a certain question. In another embodiment, the probe is algorithmically performed using web pages, client applications, or other processing tools capable of programmatic interfaces.

At step 4, for each of the participant answers to the questions or prompts, the coach checks off an acceptable answers section on the application screen. Each question has a specific set of acceptable answers. The more checks, the higher the score, up to 4. An added benefit occurs when a patient is incorrect. The prompts can affect the awareness on certain topics, increasing focus of a patient in such areas during the interim between sessions. This format is used to assure inter-rater reliability. Any coach can assess any participant at any time during their involvement in a program and the coach scores should be the same for any question. The questions are iterative in nature.

With continued reference to FIG. 4, after the questions are retrieved from a data store, they are used to determine the confidence a participant has in maintaining their health in view of a certain disease, at step 425. The process provides questions for both the participant and the worker. The participant is questioned about particular aspects. Afterward, the participant is prompted to answer certain questions or give confidence answers about certain health topics related to the participant's disease or condition. First, the social worker asks the participant question at step 430, and the patient answers the question, at step 435. Each patient answer is recorded at step 440. For each question that the participant answers, topical questions are asked to further limit the information a participant is seeking. The social worker probes the patient's knowledge of the question and answer at step 445. The questions are retrieved and related questions, which validate patient's answer to a specific question, are selected from the database at step 450. For example, in one embodiment, the MCM system is programmed to automatically select questions based on the type of content they contain in the database. Extra columns are added to the tables to provide additional information about the data, making the selection quicker. This type of automatic probing of a subject around the initial search query is different from the conventional search system and provides a targed approach for recommending content. The MCM also enables quality content choices, as the extra validation is used. The content is logically related to the initial question. In the retrieving step, the initial question is used to match to questions to validate that. The questions are presented to the participant. In an embodiment, the worker asks related question 455. However, the application can be programmed in another embodiment to automatically ask all questions associated with a certain topic. In other embodiments, the questions are narrowed. This can be done programmatically by comparing question data to topic data. If a match exists, and then the question is asked. The MCM moves through each of the related questions or stops at a predetermined number of questions per topic. If questions remain, step 455 is repeated. Then, the MCM records the patient's answer at step 460. At step 460, the system determines if further questions exist at step 455, and if not, scoring takes place. In one embodiment, the worker's score for a question is computed by 1 point per correct answer with a max of 4 for each question, at step 465. The worker's answers are recorded at step 470. Then summary information is presented at step 475. This part of the program ends at 480, with participant answers, and a confidence score for each participant answer. The MCM in some implementations reads tremendous amounts of questions and answers. Information is stored in database tables about the types of sessions. As the amount increases, the MCM also builds up special knowledge by recognizing patterns in the data that humans cannot. As the number of records increases, patterns emerge. In one embodiment, a predictive algorithm adds the step of recognizing patterns across questions and answers for participants, groups of participants, across health care providers, across entities, or any other grouping that provides quality and increases speed in the system. The patterns are used to predict content. Regression models can be applied to the data to represent the interactions between different variables. The MCM predicts where individual patients will falter, much more effectively than conventional monitoring systems. For example, the system can review thousands of patients to build intelligence around where pre-hospital admission states and which states are successful, and which states lead to admission. Then, using the MCM, focus can be placed on states that require intervention. For health care providers and insurance companies, the artificial intelligence can be used to predict downturn in costs. Capturing relationships between explanatory variables and the predicted variables from past occurrences, and exploiting them to predict the unknown outcome.

Time series models are used for predicting or forecasting the future behavior of variables. These models account for the fact that data points taken over time may have an internal structure (such as autocorrelation, trend or seasonal variation) that should be accounted for. As a result, standard regression techniques cannot be applied to time series data and methodology has been developed to decompose the trend, seasonal and cyclical component of the series. Modeling the dynamic path of a variable can improve forecasts since the predictable component of the series can be projected into the future.

There are numerous tools available in the marketplace that help with the execution of predictive analytics. These range from those that need very little user sophistication to those that are designed for the expert practitioner. The difference between these tools is often in the level of customization and heavy data lifting allowed. Notable predictive analytic tools include: Apache Mahout, GNU Octave, KNIME, OpenNN, Orange, R, scikit-learn, Weka, MATLAB, Minitab, LabVIEW, Neural Designer, Oracle Advanced Analytics, Pervasive.

MCM information includes specific statements about participant confidence and specific answers about knowledge, behavior, and action to take. It is administered to a participant and can be analyzed using software algorithms and disparate data and data sources. The MCM system relies on the convergence of members and scores. As shown in FIG. 2A, the self-knowledge score 170 is not converging. As the difference approaches 0, the MCM regards the participant's self-assessment as accurate if the assessment indicates sub-optimal knowledge, i.e., individual scores <4. This self-knowledge is an important part of the participant's progress since improving the participant's self-knowledge brings benefits beyond educational mastery. In another embodiment, self-assessment may reveal a user's knowledge of particular subjects. By relating the knowledge gaps in prior coach-led assessments to self-assessments, a predictive model can be built using statistical methods or machine learning to recommend the type of content a user could be interested in. For example, in coach-led assessments, it may be discovered that participants who rate themselves as highly confident in their ability to reduce heart failure symptoms do not often understand the effects of fluid intake on their symptoms. A website server could send a page, or probe, to a user having a list of questions about the type of music a person may enjoy. Each question could have an answer and a number of questions related to an answer. Based on the answer, a prediction can be made of the type of content a person should receive.

The characterization could involve, for example, first answering the question. With each answered question, the list of statements about the answer could be measured, e.g., answer 1 could have 5 statements associated with it, or 2, or 10, or 100. If the responder gives only 1 statement of the 5, the information could show little knowledge regarding the subject question. For example, on a music application of the invention, such as a website or mobile application, if a user is asked which bands he prefers and answers Frank Sinatra, a pre-identified list of probes is then used to characterize the user responder's level of knowledge, i.e., using the invention to judge familiarity with Frank Sinatra. However, other characterizations could be made about data based on the probe, such as confidence in caring for oneself in healthcare, or recommendations of dietary choices, or recommendations of musical compositions. The association is used to predict the most useful or informative content and eliminate manual decisions.

Returning to the Frank Sinatra example, if a user responder were to know 5 probe statements, e.g., that Frank Sinatra was from Hoboken, was in The Rat Pack, dated Marilyn Monroe, fell in love with Ava Gardner, and was in association with the mob and John Kennedy, certain predictions could be made about the user responder's depth of knowledge on the subject. Based on the predictions, content appropriate for the user could be recommended. Hereinafter, an example of how the most useful content can be found and distributed is explained.

This dashboard shows the individual participant's progress regarding the educational topics since the last time the MCM was administered. The coach uses this dashboard to determine and assess how much time should be spent discussing these topics until each topic reaches 100% in a 30-day time period. This MCM dashboard is a subset of a larger dashboard system on a per-participant level for coach workflow and behavior change planning.

Over time, optimized dose quantity and quality produces converging coach/participant scores. Conversely, diverging scores may indicate that the participant is experiencing new or additional disease management challenges, such as mental illness or newly diagnosed co-morbid conditions.

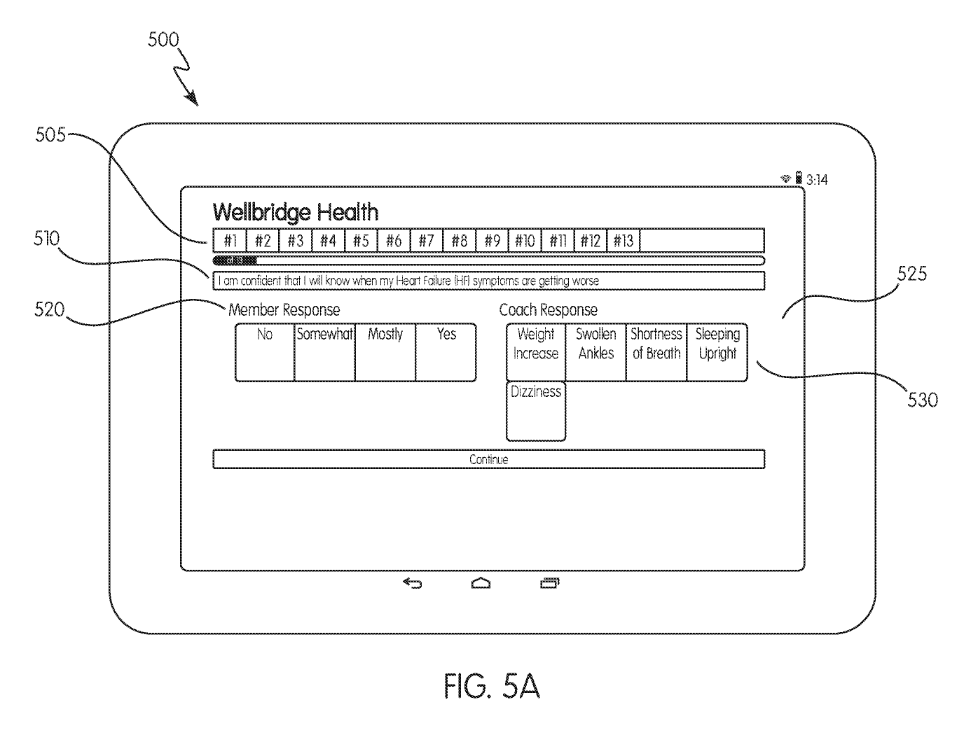

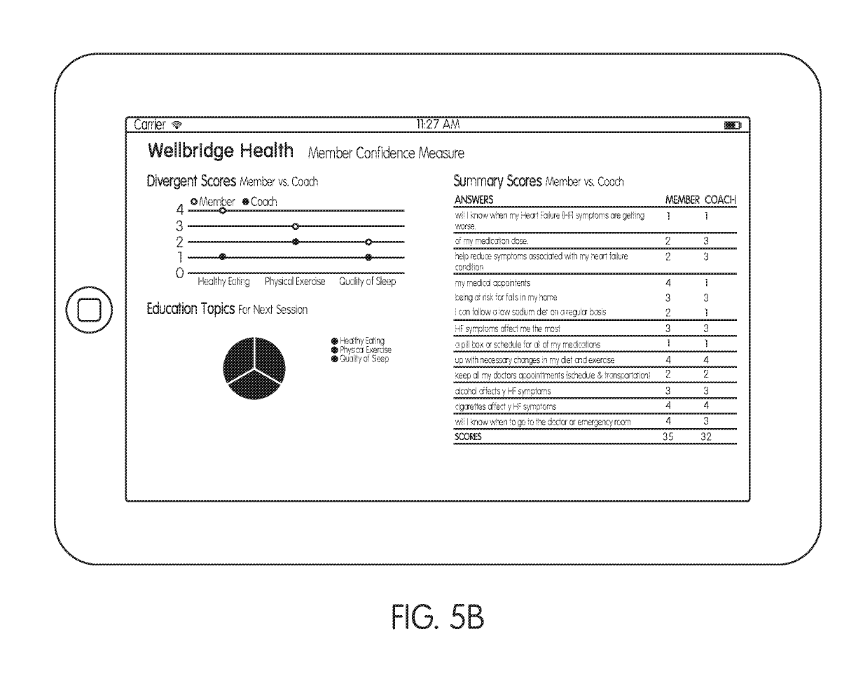

With reference to FIG. 5A, the participant's answers in an MCM confidence screen 500 are limited for control. A series 505 of prompts is used to measure the confidence of a participant. In a first question 510, the user is asked to state whether they will know when Heart Failure Symptoms are getting worse. For example, controlled answers 520 include No, Somewhat, Mostly, or Yes, where each answer corresponds to a numeric rating of 1-4, respectively. One of ordinary skill in the art would understand that other possible scaling and controls would exist. The complexity of the answers is limited to the subject matter, for example, sending the question with embedded statements that can be conditionally tested.

As shown in FIG. 5A, the system provides queues 525 to prompt the worker to coach the participant regarding their answers. Alternatively, the MCM can automatically produce questions, query the participant, and complete the validation. The coach prompts the participant for specific examples or actions that support their reported answer. A list of the accepted answers 525 is displayed to the coach. If the participant gives one of those answers, the coach fills in a check box to that example. As the patient exhausts the extent of their knowledge regarding a certain question, a tally is completed quantifying exactly how much a patient knows about a certain question. The probe is also provided to perform web pages, client applications, or other processing tools capable of programmatic interfaces.

With reference to FIG. 5B, after the recurring MCM iterations, the software is run and generates participant-specific information. Included are the top educational topics for each participant that reflect where the participant and coach scores converge for each question and other useful stats for that participant. The MCM gives hot topics based on the member answers and data. The summary screen visualizes the session information and shows areas of divergence.

FIG. 5B shows the intake screens for the MCM system for participant response and follow-up, running on a mobile device such as a tablet or computer. In FIG. 5A, the intake screen prompts the question regarding the confidence a patient has with regard to knowing symptoms of their condition, e.g., “I will know the symptoms of my condition.” The intake is configured to ensure elimination of arbitrary and subjective decision-making regarding the reliability. Inter-rater reliability controls efficacy and eliminates discrepancy when different social workers are using the system on the same questions, thus isolating dependent and independent variables of importance. These screens relate to subsequent questions for a patient to answer. The questions, as can be seen in table 1.

Returning to FIG. 5A, the intake screens for the MCM system for participant response and follow-up are shown for running on a mobile device such as a tablet or computer. With reference to FIG. 5a, the intake screen prompts the question regarding the confidence a patient has with regard to knowing symptoms of their condition, e.g., “I will know the symptoms of my condition.” The intake is configured to ensure elimination of arbitrary and subjective decision making regarding the reliability. Inter-rater reliability controls efficacy and eliminates discrepancy when different social workers are using the system on the same questions, thus isolating dependent and independent variables of importance. After this question, as described, additional screens relate to subsequent questions for a patient to answer. The questions, as can be seen in

After a question has been captured, the coach prompts the participant for specific examples or actions that support their reported answer. A list of the accepted answers is displayed to the coach. The number of choices can vary across questions or depend on other external factors. If the patient gives one of those answers, the coach assigns a check in a check box to that example. As the patient exhausts the extent of their knowledge regarding a certain question, a tally is completed quantifying exactly how much a patient knows about a certain question. Check boxes can be used for each of the participant's answers to the questions or prompts. The coach checks off an acceptable answers section on the application screen.

It should be understood that the invention is not limited to check boxes, as any input method known to one of ordinary skill in the art is possible for such an intake. Each question has a specific set of acceptable answers. The more checks, the higher the score, up to a maximum of four. An added benefit occurs when a participant is incorrect—the prompts can affect the awareness on certain topics, increasing focus of a participant in such areas during the interim between sessions.

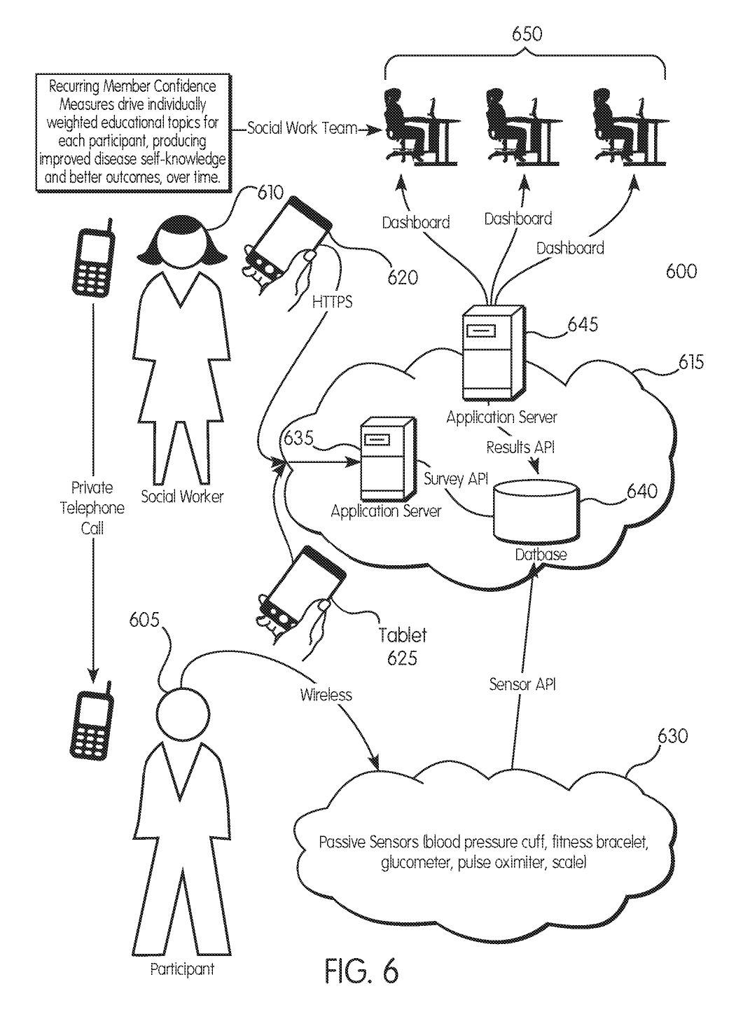

With reference to FIG. 6, recurring MCM system 600 programming drives the recommendation of individually weighted topics for each participant, producing improved disease self-knowledge and better outcomes, over time. Participant 605 and worker 610 participate using the MCM system 600 and operate a processing device that is coupled to the MCM system 600 through network cloud 615. For example, worker 610 couples to the MCM system 600 using a tablet 620 and participant couples using a tablet 625. In an embodiment of the invention, HTTP or HTTPS messages are transmitted to the tablet and programming code is sent back and forth between the tablets 620, 625 and the cloud 615. The cloud 615 is defined by application servers and databases, each having microprocessors capable of handling the requests. In addition, any number of sensors 630 can be remotely connected to the cloud 615 either directly, by configuring the sensors to communicate with an application server or database of the cloud 615, or by sending messages and updates regarding a sensed condition directly using an API. Alternatively, the sensors can be configured to send messages indirectly, through other processors, for example, a scale may be configured to attach to participant's tablet 625, the information compiled and sent from there to the MCM cloud 615. The programming code is written to distribute the handling of requests and to read and store database fields when required. In FIG. 6, the cloud is defined by an application server 635 and an application server 645 and a database. The application server 635 handles communications messages from participants and workers, such as Transmission Control Protocol (TCP), User Datagram Protocol (UDP), Internet Control Message Protocol (ICMP), Hypertext Transfer Protocol (HTTP), Post Office Protocol (POP), SMS, and other wireless protocols for WAN, LAN, ATM. Application server 635 includes programming instructions to coordinate the prompting and check-ins and messages related to the health of the participant. The application server can also parse the messages received from the participant 605 and social worker 610 and send them to a database. In addition, the application server 635 has programming to read the database and send messages to outside participants and workers. Application server 645 is programmed to receive messages from a team of workers running the MCM. These workers 650 are part of the recommendation engine. They use the dashboard shown in FIGS. 2A and 2B to get tasks. However, the recommendation engine can also be programmed into the application server. For example, based on the disease, symptoms, and participant/worker exchange of symptoms, conditions and knowledge, the application server can review the questions and answers of the participant and search automatically in a database of fields and associated key terms to find content suitable for the patient. For example, the content is scored. Based on the recurring nature of the MCM, information is stored about the participant which revises and refines the searches. For example, topics can be fine-tuned based on all of the previous questions queried, which are stored, in addition to new questions, all of which form the basis of the search. The algorithm can determine a score and find items in the database that match the score. The score can be weighted, such that the confidence measures are weighted more than the member participant answers. In such a way, the worker is able to control the recommendation indirectly.

With reference to FIG. 6, the social worker uses a processing device, such as a mobile phone, cellular enabled tablet, or computer to capture survey information about participant characteristics. For example, a survey or questionnaire can be used to guide field workers universally in terms of a subject. The information is sent to an application server and then stored in a database. In a concurrent system, a sensor network can measure physical properties of a participant, such as physical data including blood pressure, activity scores, glucose levels, pulse, and weight. The system can store information in a database. Based on the sensed data, the dashboard receives transformed informational views from the application server for use or consumption by a social worker team.

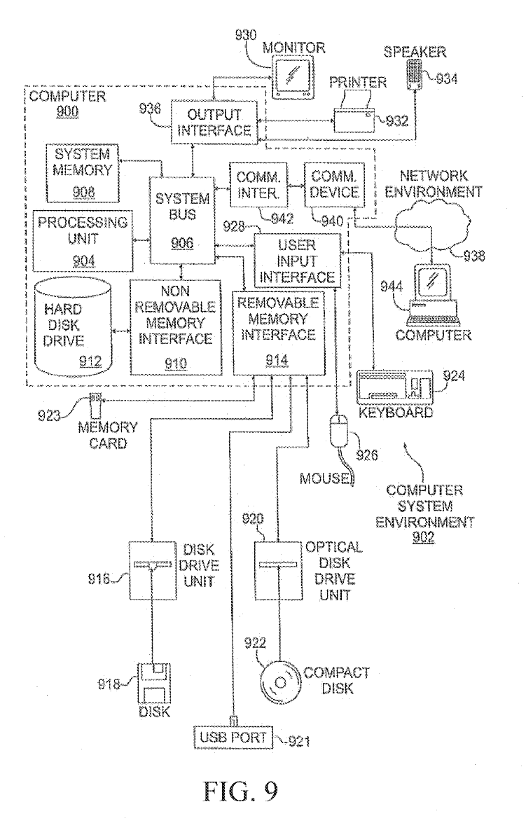

The sensor network can cover an entire member population. At an individual level, this sensor network consists of a scale, pulse oximeter, blood pressure cuff, glucometer, and activity/sleep-tracking bracelet. Each of these devices can connect wirelessly, either using Bluetooth® Low Energy or WI-FI, through a tablet mobile device, or directly through the Internet using 2G/3G/4G cellular data. FIG. 9 discussed herein below, provides additional examples of technological platforms. This system provides a passive feedback loop of passive sensor data flows, including activity, blood oxygen, blood pressure, blood glucose, pulse, sleep, and weight. The system can be a client-server design, such as the web, using HTML and JavaScript over HTTP or it can also take the form of a Peer-to-Peer (P2P) system. Also, message broker or message bus systems can be used.

Returning to FIG. 3, a use-case diagram describing an exemplary weighting for topics of education, the MCM is not a unilateral self-assessment. The participant score and coach score on each question can be different. To obtain behavioral examples and other sources of data to support or deny the participant's level of confidence, knowledge, and potential for behavior change of a given topic, analysis of participants and cross participants is taken.

With continuing reference to FIG. 3, the system is shown for a healthcare embodiment. However, this is exemplary because it is known the system can be used for any content-based system to retrieve information. For example, after the question(s) and probe(s), the participant's knowledge is validated. The validated knowledge is used to assign weighted topics, e.g., weighted educational topics. However, the invention can be used to solve a problem with determining user-specific interest. For example, on the World Wide Web, generic web pages are frequently of interest to casual browsers. The invention would make it easier for websites to predict a user's interest and serve pages tailored to a user. For example, a medical site's predictive model server could retrieve answers and probe information in order to help a user responder self-diagnose or treat a condition remotely. As the measured probe scores become more indicative of awareness and knowledge, deeper information could be given on a subject. This is leading toward a statistical or machine learning method where, within a massive open online course, the next most valuable content for a user can be predicted based on the assessment of the user's mastery of prior content. This would allow a user to take an adaptive path through successive user's content n, where the user's content n can be predicted adaptively, using the previous content n−1. Thus, the user's mastery of content n−1 determines the conditional path through successive content n, n+1, n+2, etc.

The content database can be structured to store content to facilitate the predictive model server in association to probes, e.g., probe levels can be 1-4. Content with a probe level 1, 2, 3, 4, etc. associated with a topic can be distributed to a user meeting such criteria. The combination of answer-probe level groups can further define the content distribution.

With reference to FIGS. 5A, 5B, after all iterations, the software generates participant-specific information and programs application software for displaying, changing, editing, and updating the information. Included are the top educational topics for each participant that reflect where the participant and coach scores converge for each question and other useful stats for that participant. The MCM gives hot topics based on the member answers and data. The summary screen visualizes the session information and shows areas of divergence.

The MCM system can provide numerous reports at the individual, chronic condition, client (i.e., health plan), and even population/business level. Typical recurring reports would include individual participant progress over time and progress with specific confidence statements. Queried results can provide useful data for decision making and clinical judgment on behalf of the coach.

For each question of the MCM, there are one or more external data sources to validate the participant and coach scores. This allows the MCM system to pull data from different places, add sentiment data and other analytics, and to produce new meanings, patterns, themes, and overall understanding of each participant over time, as well as any subset or entirety of participants at any given time.

Sentiment analysis (unstructured data) can come from coach session notes, often in the form of open text, as well as digital dialogue, transformed by speech-to-text, captured during a video chat.

Structured data can include, but are not be limited to, device data (scale, glucometer, pulse oximeter, blood pressure cuff, and wearables), claims data (PCP, IP, ER, HgA1C), assessment scores, pharmacy data and types of medications, and neurocognitive screens and assessments. The combination of structured and unstructured data creates actionable outcomes for the coach and the team, while eliminating unnecessary decision making by the coach, in addition to creating clinical business projections for the client.

Additional predictive analytics are directed toward cases, conditions, and measures to determine where there are failures so that the coach is able to review and alter interventions to shift behavior change. Predictive analytics is often defined as predicting at a more detailed level of granularity, i.e., generating predictive scores (probabilities) for each individual organizational element. This distinguishes it from forecasting. For example, “Predictive analytics—Technology that learns from experience (data) to predict the future behavior of individuals in order to drive better decisions.” In future industrial systems, the value of predictive analytics will be to predict and prevent potential issues to achieve near-zero break-down and further be integrated into prescriptive analytics for decision optimization. Furthermore, the converted data can be used for closed-loop product life cycle improvement which is the vision of Industrial Internet Consortium.

The sensor network provides valuable correlation data. As a result of these data flows, the health system can establish correlations of its MCM system. For instance, in a participant with diabetes, if the average blood glucose level, measured several times per day, is decreasing over time, the MCM would be expected to correlate with behavior change in the participant (in this case, the change is in blood glucose level).

There are three possible patterns for this correlation. Different patterns may be associated with different subgroups of the member population.

The first pattern is simple correlation without any temporal lead-lag, i.e., the sensor data (glucose level) and MCM are moving simultaneously. This indicates that the members are simultaneously developing both the behavioral changes that affect the sensor data and the ability to accurately describe those behavior-change sensor data drivers as measured by the MCM.

A second pattern would be when a participant's sensor data (glucose level in this example) are improving but the member and coach confidence measure on the MCM are not yet converging. Then we may question whether the MCM is sufficiently tuned to accurately predict the participant's behavior. In this case, it indicates that the daily feedback level from the sensor data measurements is driving behavior change ahead of the member's ability to accurately describe the behavior change factors.

The third pattern would be when a participant's sensor data (again, blood glucose level in this example) are not yet improving, but the member and coach scores from the MCM are converging. Then, the MCM may provide a leading indicator of behavior change in the participant. The member's ability to describe the required behavior changes anticipates the actual behavior changes and derived improvement in the sensor data.

FIG. 5A shows an example of the intake screens for the MCM system for participant response and follow-up, running on a mobile device such as a tablet or computer. FIG. 5a, the intake screen prompts the question regarding the confidence a patient has with regard to knowing symptoms of their condition, e.g., “I will know the symptoms of my condition.” The intake is configured to ensure elimination of arbitrary and subjective decision-making regarding the reliability. Inter-rater reliability controls efficacy and eliminates discrepancy when different social workers are using the system on the same questions, thus isolating dependent and independent variables of importance. After this question, additional screens relate questions for a patient to answer that can be related tangentially or directly. FIG. 5A is associated with a set of mutually exclusive buttons. Each of the buttons is assigned a numeric variable, e.g., 1, 2, 3, 4. The captured answer is converted to a numeric value and stored. The total number of questions used for each MCM varies based on the number of chronic conditions being addressed for each participant. The total score will be dependent on the overall number of questions as well.

Group and aggregate score comparison can be used with the questions and answers after the validation step of FIG. 4. First, isolate an answer or enhancement to view the correlation of that data item with the effected change across individual and group. Then the system can be programmed to auto-eliminate questions which are not effective. The system can also auto create new patterns.

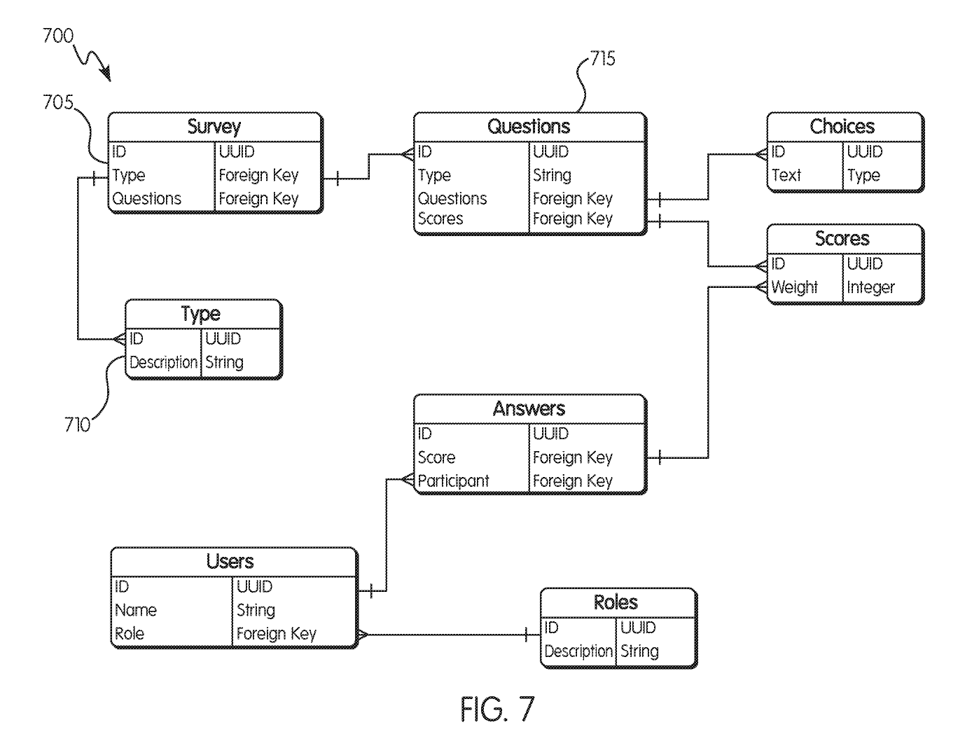

With reference to FIG. 7, a relational schema 700 describes the logical definition of tables in the MCM including the name of the table, and what the name and type of each column is. The schema 700 is the collection of relation schemas for the core MCM. Each table of the MCM is represented in schema 700 and shows bunches of rows (aka “tuples”), and the attributes defined by the schema. The database schema 700 shows the structure of the database and defines the organization of data of the MCM database showing logically how it is constructed. In the schema diagram, all of the database tables are designated with unique columns and special features, e.g., primary/foreign keys or not null, etc. The table relationships also are expressed via a parent table's primary key lines when joined with the child table's corresponding foreign keys. For example, the table survey 705 has a field type 710 which joins the survey table 705 with the table questions 715, joining the field ID. This diagram of the stored data relating to the MCM administration includes surveys, questions, and choices. Stored data relating to the users can also be demographic, such as name, address, chronic conditions, and emergency contacts. In addition, the date administered and the condition are captured, as well as relations to answers and roles.

Data can be stored as an object, such as a variable, a data structure, or a function, and as such, is a location in memory having a value and possibly referenced by an identifier. Object can also refer to a particular instance of a class where the object can be a combination of variables, functions, and data structures. In a database, such as a relational database, an object can be a table or column, or an association between data and a database entity, such as relating an area to a species.

Direct SQL execution is attained by translating a model from its “native” representation to SQL representation. For example, there are tools like pmml2sql and KNIME to translate most common model types from PMML to SQL. Intermediated SQL execution stays in its “native” representation. The evaluation is handled by a dedicated model evaluation engine that is tightly integrated into the database backend. For example, PostgreSQL database supports the execution of arbitrary R and Python application code via PL/R and PL/Py procedural languages, respectively. This approach is technically quite demanding, because it crosses SQL and application programming domains. The life of SQL end users can be made somewhat easier by (automatically) generating an appropriate SQL wrapper function for every model. External execution is deployed to a dedicated model evaluation engine that is separate from the database backend. Such model evaluation engine could be “shared” between several applications and services, which leads to the concept of “organization's predictive analytics hub”.

With reference to FIG. 8, the dose tracking 110 shown in FIG. 2a, is entered using an intake application 800 of FIG. 8, to capture the status of the patient. This information is entered into the MCM equation. Intake 800 includes information about conditions of the participant. The participant uses intake 800 at the time of check-in to update physical information, such as ankle swelling, shortness of breath, sleep position, dizziness, and mood. In addition, other questions are used that measure coherency in the system, and that information is used for display. Dose tracking 110 of FIG. 2a is then used to show some of these check-ins fields, average check-in 135, and number of cancellations. For example, intake 800 includes ratings for mood 805, using icons to indicate changes in mood. A processor receives the participant's mood data associated with a target condition and representative of a participant's mood and health in association with the target condition. Part of the recommendation of content engine uses the patient's mood and is indicated using a spectrum of icons, the icons visually indicating the type of mood they represent.

The present invention may be implemented on a variety of computing devices and systems, including the mobile devices and/or server computer, wherein these computing devices include the appropriate processing mechanisms and computer-readable media for storing and executing computer-readable instructions, such as programming instructions, code, and the like. As shown in FIG. 9, personal computers 900, 944, in a computing system environment 902 are provided. This computing system environment 902 may include, but is not limited to, at least one computer 900 having certain components for appropriate operation, execution of code, and creation and communication of data. For example, the computer 900 includes a processing unit 904 (typically referred to as a central processing unit or CPU) that serves to execute computer-based instructions received in the appropriate data form and format. Further, this processing unit 904 may be in the form of multiple processors executing code in series, in parallel, or in any other manner for appropriate implementation of the computer-based instructions.

In order to facilitate appropriate data communication and processing information between the various components of the computer 900, a system bus 906 is utilized. The system bus 906 may be any of several types of bus structures, including a memory bus or memory controller, a peripheral bus, or a local bus using any of a variety of bus architectures. In particular, the system bus 906 facilitates data and information communication between the various components (whether internal or external to the computer 900) through a variety of interfaces, as discussed hereinafter.

The computer 900 may include a variety of discrete computer-readable media components. For example, this computer-readable media may include any media that can be accessed by the computer 900, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 900. Further, this computer-readable media may include communications media, such as computer-readable instructions, data structures, program modules, or other data in other transport mechanisms and include any information delivery media, wired media (such as a wired network and a direct-wired connection), and wireless media. Computer-readable media may include all machine-readable media with the sole exception of transitory, propagating signals. Of course, combinations of any of the above should also be included within the scope of computer-readable media.

The computer 900 further includes a system memory 908 with computer storage media in the form of volatile and non-volatile memory, such as ROM and RAM. A basic input/output system (BIOS) with appropriate computer-based routines assists in transferring information between components within the computer 900 and is normally stored in ROM. The RAM portion of the system memory 908 typically contains data and program modules that are immediately accessible to or presently being operated on by processing unit 904, e.g., an operating system, application programming interfaces, application programs, program modules, program data and other instruction-based computer-readable codes.

With continued reference to FIG. 9, the computer 900 may also include other removable or non-removable, volatile or non-volatile computer storage media products. For example, the computer 900 may include a non-removable memory interface 910 that communicates with and controls a hard disk drive 912, i.e., a non-removable, non-volatile magnetic medium; and a removable, non-volatile memory interface 914 that communicates with and controls a magnetic disk drive unit 916 (which reads from and writes to a removable, non-volatile magnetic disk 918), an optical disk drive unit 920 (which reads from and writes to a removable, non-volatile optical disk 922, such as a CD ROM), a Universal Serial Bus (USB) port 921 for use in connection with a removable memory card, etc. However, it is envisioned that other removable or non-removable, volatile or non-volatile computer storage media can be used in the exemplary computing system environment 900, including, but not limited to, magnetic tape cassettes, DVDs, digital video tape, solid state RAM, solid state ROM, etc. These various removable or non-removable, volatile or non-volatile magnetic media are in communication with the processing unit 904 and other components of the computer 900 via the system bus 906. The drives and their associated computer storage media discussed above and illustrated in FIG. 4 provide storage of operating systems, computer-readable instructions, application programs, data structures, program modules, program data and other instruction-based computer-readable code for the computer 900 (whether duplicative or not of this information and data in the system memory 908).

A user may enter commands, information, and data into the computer 900 through certain attachable or operable input devices, such as a keyboard 924, a mouse 926, etc., via a user input interface 928. Of course, a variety of such input devices may be utilized, e.g., a microphone, a trackball, a joystick, a touchpad, a touch-screen, a scanner, etc., including any arrangement that facilitates the input of data, and information to the computer 900 from an outside source. As discussed, these and other input devices are often connected to the processing unit 904 through the user input interface 928 coupled to the system bus 906, but may be connected by other interface and bus structures, such as a parallel port, game port, or a universal serial bus (USB). Still further, data and information can be presented or provided to a user in an intelligible form or format through certain output devices, such as a monitor 930 (to visually display this information and data in electronic form), a printer 932 (to physically display this information and data in print form), a speaker 934 (to audibly present this information and data in audible form), etc. All of these devices are in communication with the computer 900 through an output interface 936 coupled to the system bus 906. It is envisioned that any such peripheral output devices be used to provide information and data to the user.

The computer 900 may operate in a network environment 938 through the use of a communications device 940, which is integral to the computer or remote therefrom. This communications device 940 is operable by and in communication to the other components of the computer 900 through a communications interface 942. Using such an arrangement, the computer 900 may connect with or otherwise communicate with one or more remote computers, such as a remote computer 944, which may be a personal computer, a server, a router, a network personal computer, a peer device, or other common network nodes, and typically includes many or all of the components described above in connection with the computer 900. Using appropriate communication devices 940, e.g., a modem, a network interface or adapter, etc., the computer 900 may operate within and communication through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 900, 944 may be used.

As used herein, the computer 900 includes or is operable to execute appropriate custom-designed or conventional software to perform and implement the processing steps of the method and system of the present invention, thereby, forming a specialized and particular computing system. Accordingly, the presently-invented method and system may include one or more computers 900 or similar computing devices having a computer-readable storage medium capable of storing computer-readable program code or instructions that cause the processing unit 902 to execute, configure or otherwise implement the methods, processes, and transformational data manipulations discussed hereinafter in connection with the present invention. Still further, the computer 900 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A recommendation engine for a participant care system for assimilating knowledge of a condition into a lifestyle to reduce rehospitalization time and providing information comprising:
a survey database, comprising a plurality of data fields representing initial data associated with a member's self-knowledge, which includes self-assessment associated with a first topic;
a question database, comprising a plurality of data fields representing questions about a number of topics, which includes assessment questions about the first topic;
an assessment answers database, comprising a number of statements, each statement an answer to at least one of the questions in the question database;
a sensors database, comprising a plurality of data fields representing sensed data, which includes information communicated from sensors and associated with a participant;
a processing device in communication with the survey, question, answer, and sensor databases and configured to recommend content and programmed to:
receive at least one data field from the survey database;
receive a plurality of fields from the question database which are associated with the at least one received survey field; and
determine a confidence score for the questions based upon answers from the assessment answers database, wherein inter-related answers are determined by comparing the at least one field from the survey database with the fields from the question database, and used to validate a participants self-reported answers to questions about a health condition; and
recommending content based on predictions formed from the confidence score in the database and used to identify content for a user based on the confidence score,
wherein the validation score is calculated based on the answers received from the participant, that match those determined to be inter-related assessment answers, the score associated with the question, wherein the question is associated with a topic and based on the score, recommending the topic, and
wherein a score for the question is determined from the inter-related answers, the questions having a weighted score and associated with specific content related to the topic.

2. The recommendation engine of claim 1, wherein the processor receives mood data associated with a target condition and representative of a participant's mood and health in association with the target condition.

3. The recommendation engine of claim 2, wherein the received mood data is indicated using a spectrum of icons, the icons visually indicating the type of mood they represent.

4. The recommendation engine of claim 1, wherein scored patient input data is stored.

5. The recommendation engine of claim 4, where the scored patient input data is associated with at least a first and second time point and relating to a patient's condition.

6. The recommendation engine of claim 4, transmitting the stored scored patient input and confidence measurement to a patient data center.

7. The recommendation engine of claim 1, wherein scores for participants are combined to show trends across a group of users.

8. The recommendation engine of claim 1, wherein the scores are used to predict program success, failure, or efficacy, for controlled variable information and conditions.

9. A method of treating a patient using a member confidence measure (MCM) system to identify content relevant to a user's associated condition, the method comprising the steps of:
sending a message to remotely probe a patient, the probe related to the patient's understanding of a health condition;
receiving a probe response, said response comprising statements, wherein the statements are associated with measure scores and indicate recommended content as a function of the score; and
sending content based on a predictive model using said statements.

10. The method of claim 9, comprising the step of measuring the patient's awareness of the health condition using the received responses from the patient to self-assessment questions.

11. The method of claim 9, wherein the step of the received responses from a health care worker are associated with the accuracy of patient responses.

12. The method of claim 9, wherein the health care worker prompts the patient with targeted questions.

13. The method of claim 9, wherein specific prompts associate with self-assessment questions of the patient.

14. The method of claim 9, wherein each question targets a symptom or aspect of the patient response and the scores for each question are combined.

15. The method of claim 9, wherein accuracy of patient responses is measured by comparing responses of the patient and a worker.

16. The method of claim 9, wherein determining topics for increasing awareness of a health condition uses weighted topics, wherein the weighted topics are scaled to provide at least one topic related to the patient's condition.

17. A participant care system for affecting behavioral change in a participant having at least one associated sensor and at least one member confidence model computer programmed to:
determine a validation score associated with a participant's actual health condition, based on questions and scored statements about a participant's behavioral knowledge; and
during treatment of the participant's health condition, determining an actual status of the condition with sensors and reporting of physical condition,
wherein a confidence model is generated based on a validation score and participant reports, the model also receiving actual data from sensors associated with a health condition and measuring actual status of the participant, and
wherein:
a) if the actual data moves with the change in member confidence measure (MCM) measurement then predicted behavioral changes will continue to affect the sensor data; or
b) if the actual data changes are opposite the MCM measurement, then the MCM is not tuned yet and not affecting actual change; or
c) if the actual data is unchanged and the MCM measurement moves, then predicted actual changes are anticipated as a result of learned behavioral changes.

18. The participant care system for affecting behavioral change of claim 17, wherein the step of determining the validation score is recurring and the MCM measurements are stored and reused for subsequent validations to determine the MCM measurement.

19. The participant care system for affecting behavioral change of claim 17, wherein the MCM measurement validation score is calculated based at least partially on answers received from the participant, and inter-related assessment statements, for recommending content.

20. The participant care system for affecting behavioral change of claim 17, wherein a score for the question is determined from the inter-related answers, the questions having a weighted score and associated with specific content related to the topic.
